(19) United States
(12) Patent Application Publication
(10) Pub. No.: US 2010/0096338 A1
(43) Pub. Date: Apr. 22, 2010

(54) Management arrangement

(76) Inventors: Riccardo Arthur De Wet, Gordon's Bay (ZA); Daniel Alfonso Corte, Strand (ZA); Uwe Thuss, Chemnitz (DE)

Correspondence Address: Friendrich Von Rohrscheidt, 7400 Whitepine Road, Richmond, VA, 23237, US

(21) Appl. No.: 12/586,537

(22) Filed: Sep. 23, 2009

Related U.S. Application Data
(63) Continuation-in-part of application No. 10/503,535, filed on Mar. 30, 2005, now abandoned.

(30) Foreign Application Priority Data
Feb. 4, 2002 (ZA) 2002/0955

(51) Int. Cl. E04H 4/14; C02F 1/00; C02F 1/32; C02F 1/46; G05D 27/02

(52) U.S. Cl. 210/739; 210/143; 210/149; 210/96.1; 210/103; 210/97; 210/85; 210/87

(57) ABSTRACT

The invention discloses a management arrangement for a swimming pool. The arrangement includes a number of sensors being adapted to measure variables and generate input data relating to a swimming pool. The input data is processed by a processing unit to generate output data, which data is then used by an actuator to control equipment. Various operating parameters are programmable into the processing unit via an operator interface. The arrangement provides a combination of ultraviolet treatment and ion enrichment in order to disinfect or purify the water. The arrangement specifically regulates the ionization of the swimming pool water so as to substantially maintain a pre-determined ion concentration level with reduced operator intervention.

This application is a Continuation-in-Part application from U.S. application Ser. No. 10/503,535, filed on Mar. 30, 2005, which was the U.S. National Stage of International Application No. PCT/IB02/05053, filed on Dec. 2, 2002, which claims priority from South African Application No. 2002/0955, filed on Feb. 4, 2002. This application claims priority from the foregoing applications.

### FIELD OF INVENTION

The present invention relates to a management arrangement. More particularly, the present invention relates to a management arrangement for regulating the treatment of water in swimming pools.

### BACKGROUND OF INVENTION

Water contained in swimming pools needs to be treated on a regular basis, e.g. to prevent the water from stagnating and becoming infested with algae. This treatment typically requires the cleaning of the swimming pool filter, e.g. backwashing, and the addition of certain chemicals, such as acid and chlorine, to the water. These chemicals are corrosive and can be dangerous if not handled or stored correctly. If an excessive quantity of the chemicals is added to the water, the water will also become unbalanced and will display unwanted characteristics, e.g. such as becoming milky.

One method of overcoming these problems is to use a chlorinator unit, which generates chlorine by the dissociation of salt. This allows a regular supply of chlorine into the water without requiring constant supervision. However, a person must still manually backwash the swimming pool and check whether enough salt is available in the water for the chlorinator unit to operate.

It is therefore an object of the invention to suggest a management arrangement which will assist in overcoming these problems.

It is a further object of the invention to provide a system for regulating the ion concentration of the water in a swimming pool while minimizing the need for operator involvement.

It is a further object of the invention to implement a system for treating the water in a swimming pool that assists in a more efficient utilization of certain water treatment materials and reduces power requirements under certain conditions.

It is a further object of the invention to provide and to regulate an ultraviolet unit and an ionization unit to maintain constant disinfection of the water of a swimming pool.

It is a further object of the invention to provide and to regulate an ionization unit in such a manner as to minimize the use of electrode material in the ionization unit.

### SUMMARY OF INVENTION

According to the invention, a management arrangement for a swimming pool includes a number of sensors being adapted to measure variables and generate input data relating to a swimming pool; a processing unit being adapted to receive the input data and to generate output data; an actuator adapted to control equipment in response to the output data; and an operator interface adapted to allow programming of operating parameters into the processing unit.

The arrangement may include a variety of elements, including, but not limited to, an ionization sensor device and a control device which assist in the regulation of the ion concentration in the water of the swimming pool.

### BRIEF DESCRIPTION OF THE DRAWINGS

FIG. 1 provides a block diagram of a management arrangement in accordance with the invention.

FIG. 2 is an illustrative view of the ultraviolet unit and the ionization unit.

FIG. 3 is a perspective view of the ultraviolet unit and the ionization unit.

FIG. 4 is a front view of the ionization unit.

FIG. 5 is a side view of the ionization unit.

FIG. 6 is a top view of the ionization unit.

FIG. 7 is a perspective view of the ionization unit.

FIG. 8 is a combined side and top view of the electrodes of the ionization unit.

### DETAILED DESCRIPTION OF THE PREFERRED EMBODIMENT

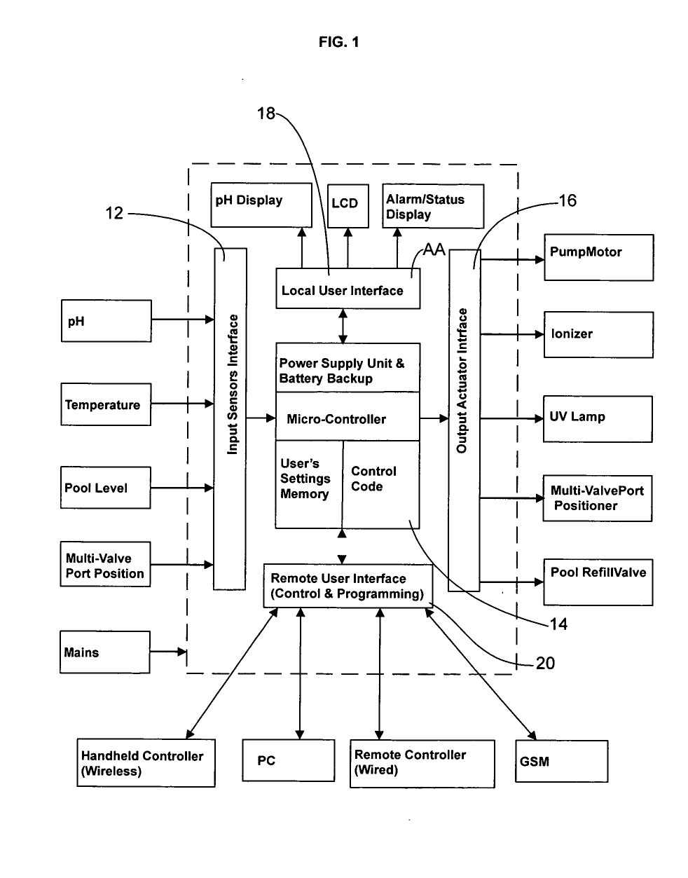

Referring to FIG. 1, a block diagram of a management arrangement in accordance with the invention, generally indicated by reference numeral 10, is shown. The management arrangement 10 is used for regulating the purity and flow of water in swimming pools and is operatively joined to a swimming pool pump and filter. The pump is provided with a multi-valve port having commonly known functions such as “filter”, “backwash”, “rinse”, “waste”, and “bypass”.

The management arrangement 10 includes an input sensor interface 12 adapted to receive input data regarding the pH, temperature and water level of the swimming pool water, and the selected function of the multi-valve port. The input data is transmitted to a micro-controller 14, which is programmed with software adapted to interpret the information. The software is programmable with certain settings, e.g. the duration of operation of the swimming pool pump, the frequency that the filter should be backwashed, etc. . . . The micro-controller 14 is further operatively joined to an output actuator interface 16, a local operator interface 18 and a remote operator interface 20.

The output actuator interface 16 is used to operate water purity and flow equipment, such as the swimming pool pump, the multi-valve port, an ionization unit, an ultraviolet unit and a pool refill valve.

The local operator interface 18 displays information regarding the input data and the operational status of the management arrangement 10. The remote operator interface 20 is used to control the operation of the management arrangement 10 and to program the required settings into the software of the micro-controller 14.

During use, a person activates the management arrangement 10 and enters the required settings into the software. The management arrangement 10 will then automatically activate the swimming pool pump at the programmed intervals and filter the swimming pool water. While idling between the filtration cycles, the pH of the water is displayed on the local user interface 18. The water level of the pool is also checked and, if required, is topped up by opening the pool refill valve.

The pH value of the water is constantly monitored. When the pH value varies from the ideal value 7.0, an indicator on the local operator interface 18 will burn red or yellow. The indicator will burn when the weekly maintenance time arrives. The management arrangement 10 guides a person through the maintenance procedure by displaying the steps to be followed on a LCD (liquid crystal display) on the local operator interface 18. The user will be prompted to add the correct amount of chemical needed to balance the pool (according to the programmed pool size and the actual pH value).

The management arrangement includes an ionization unit, also known as an ionizer, and an ultraviolet unit. A combination of ultraviolet treatment and ion enrichment is provided in order to purify the swimming pool water and inhibit bacterial growth. In the preferred embodiment, the ionization unit is adapted to generate either activated copper or activated magnesium ions in the swimming pool water. The metal used, and subsequent type of ions disbursed, may be drawn from any metal suitable for ion generation under the conditions disclosed herein, e.g. copper or silver. During a filtration cycle, the swimming pool pump is started and, after water circulation has commenced, the ultraviolet unit is switched on and the ionization unit is switched on.

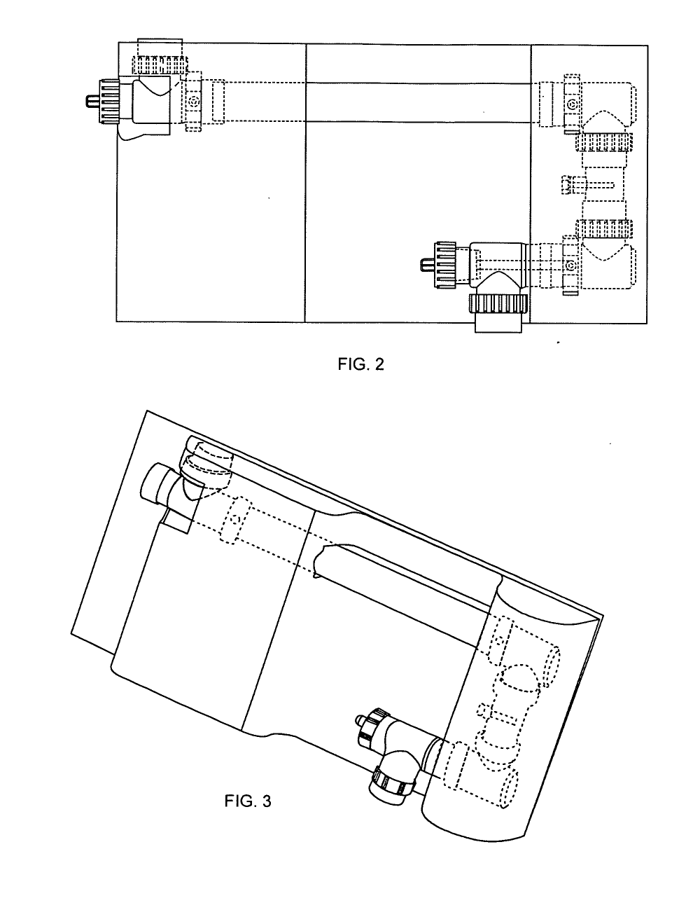

Referring now to FIGS. 2 and 3, the ionization unit and the ultraviolet unit are typically disposed in a single housing. The ultraviolet unit has a germicidal lamp with an output of between 7 Watt and 115 Watt, depending on the flow rate and functions to destroy all water borne bacteria, germs, viruses and fungi passing therethrough. The ultraviolet unit allows chemical-free disinfection of the water and is also able to remove combined chlorine molecules (chloramines and organic pollutants). The ultraviolet treatment is continuous in nature so long as the circulating pump is active and operates according to a flow-through principle. The ultraviolet unit may be operated on a time delay in relation to the start of the circulation pump in order to prevent the ultraviolet lamp from overheating. A photo cell may be used to monitor the intensity of the ultraviolet radiation in order to insure effective levels of irradiation.

The management arrangement is able to regulate the ion concentration in the water so as to substantially maintain such concentration at pre-determined levels. The ion concentration is, in part, a function of the ionization current. The ionization current may be controlled, i.e., increased, decreased, or maintained, through manipulation of the voltage supplied to the ionization unit. Through the manipulation of the voltage, the system is able to maintain the pre-determined ion concentration. The size of the swimming pool is critical to the ionization process as the maximum ionization power is a function of the pool size. In the preferred embodiment, the ion concentration is generally regulated within the range of 0.5 to 0.8 ppm through the processes disclosed herein. The ionization of the water is primarily responsible for inhibiting the growth of new bacteria and other contaminants.

In one embodiment, the management arrangement uses various operating parameters and other collected information in order to indirectly calculate the ion concentration. In such an embodiment, the management arrangement collects information from one or more sensors which measure various parameters of the swimming pool water, such as temperature, pH level, and conductivity. The management arrangement may also rely upon additional information, such as total water volume, which may be collected via sensor or input by a user through the Local User Interface or the Remote User Interface. Once this information is obtained, the management arrangement calculates the approximate ion concentration through cross-reference with a value table. The management arrangement then compares the calculated ion concentration value to the desired, pre-determined value, and regulates the ion concentration as may be necessary in order to achieve, or maintain, the pre-determined value.

In a second embodiment, the management arrangement directly measures the ion concentration through an ion sensitive sensor complex. Such devices are known in the art and any such device, such as a diaphragm electrode, may be used. Ideally, the sensor complex should include a double galvanic separation into multiple layer plates in order to reduce or eliminate the effect of electromagnetic interference. It will be recognized that in any embodiment which includes an ion concentration sensor, there will not be any need for the management arrangement to evaluate other parameters in order to indirectly determine the ion concentration of the pool water.

The ionization unit operates with a variety of settings, including, a water inlet or boost mode, a summer mode or a winter mode setting. The water inlet setting is primarily for new swimming pools where maximum ionization is required. In this setting, ion enrichment is a function of the total pool volume with an ionization current of 200 mA. In the summer mode, ion enrichment is a function of temperature as follows:

| | |
|---|---|
| 36° C. | 100% ionization current |
| 25° C. | 75% ionization current |
| 20° C. | 50% ionization current |
| 15° C. | 25% ionization current |
| <15° C. | 10% ionization current |

In winter mode, ion enrichment is fixed with an overall reduction in ionization. Specifically, an ionization of 10% at 20 mA is set in winter mode.

After the swimming pool is stabilized, the ionization setting is reduced and regulated to ensure that the correct amount of activated ions are present in the water as the water temperature fluctuates between summer and winter temperatures.

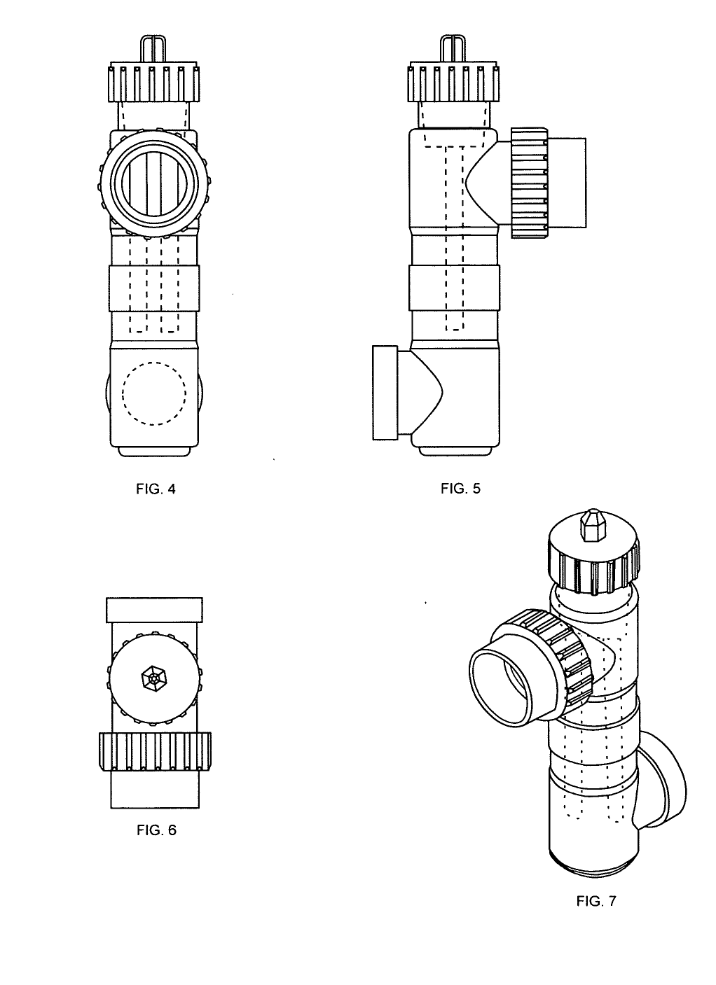

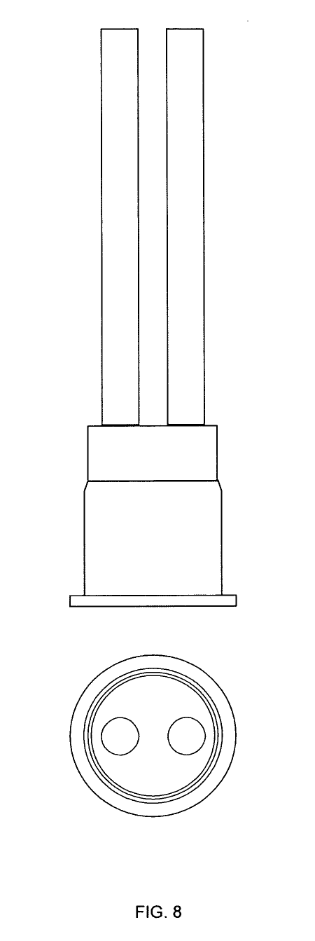

Referring to FIGS. 5-8, the ionization unit is provided with suitable electrode distances and optimized flow-through geometry so as to maximize its effectiveness. The ionization unit includes at least a first aperture for water input and at leas,t a second aperture for water output. When the ionization unit is installed in the system, the water input aperture is located at the bottom of the device and the water output aperture is located at the top of the device. As seen in FIG. 2 and FIG. 7, the ionization unit is configured so that the water enters the bottom of the device and the water exits at the top of the device, this provides a lateral and an elevation offset between the input and output flows. This configuration assures that the ionization unit is always sufficiently filled with water, and no air pockets can form even when the circulation pump is turned off. Air pockets are to be avoided as they could lead to an oxidation of the anodes and, consequently, to a covering of the anode surfaces. Such oxidation coverings can cause insufficient voltage at the beginning of the ionization process and can severely limit the ionization performance. Furthermore, the lateral and elevation offset of the water input and the water output, in combination with the centrally disposed anodes, assist in achieving optimal flow properties, i.e., the turbulent flow improves the distribution and flushing of the dissolved ions in the water flowing through the device. The defined configuration of the anodes assures that the electrical field generated reaches the optimal desired field strength and an optimum ion release is accomplished. The configuration also allows for control of the wear direction of the anodes. The polarity of the electrodes may be also reversed after a predetermined period of time in order to prevent unilateral wear.

The wear of the electrodes can be monitored through optical detection, as is known in the art. When an electrode has worn to a pre-determined level, the operator may be notified that a replacement is necessary through the LCD, the alarm/status display, or a remote user interface.

As discussed above, the pH value of the water is monitored and the value is output to the pH display or any suitable means of display. The pH value must also be maintained within a set range so as to insure effective ionization of the water. In systems employing copper ionization, the pH must be maintained at a value at or above 6.7 and below 7.1. If the pH is not kept below 7.1, precipitation of the copper, as copper hydroxide, will occur.

The ionization unit is installed after the ultraviolet unit component, since the ultraviolet treatment causes a significant reduction in germ content already. Ions are disbursed in the water only after the UV sterilization process. In order to stay active longer, the ions are disbursed into sterilized water. Furthermore, the measurement sensor or sensors are disposed in front of the ionization, so that the dissolved ions cannot interfere with the measurement results, and so that the actual parameters of the water in the pool are properly analyzed by the sensor or sensors.

A backwash cycle can be performed either after a predetermined period of time or when demanded by the pump power control.

The management arrangement 10 automatically operates multi-valve port, i.e. filter—backwash—rinse—filter, and also switches the swimming pool pump on and off as needed.

The management arrangement may also include protective circuitry which will deactivate various elements, e.g., the ultraviolet unit, if the circulating pump is deactivated or fails. This will prevent damage to the various elements. For instance, this will prevent the ultraviolet unit from burning out if there is insufficient water flow. The protective circuitry can encompass various means but one such means includes monitoring the pump current of the circulating pump. Further, the management arrangement provides an error message through the LCD, the alarm/status display, or a remote user interface when there is no flow-through water movement.

The management arrangement 10 is further provided with a secondary battery power supply, so that in the event of a mains power failure, any backwash cycle is terminated and the multi-valve port is returned to its filter position, thereby assuring that no water drains out from the swimming pool. Although a person's settings are retained and the real time clock is unaffected, the ionizing and ultraviolet units will be suspended until the mains power is restored.

A person can bypass any programming schedule with a “manual” mode. This allows any test/maintenance of the swimming pool to be performed under their supervision. A wireless hand held remote controller is provided so that the person does not need to open the management system's enclosure to program or fully control the manual operation.

The management arrangement 10 can be interfaced with digital communication equipment to allow automated remote control. The management arrangement includes a remote interface that may be operatively connected via infra-red, radio, or cellular signals. The management arrangement may be thus accessed and controlled by a variety of devices including a hand-held remote control, a computer, a personal digital assistant, or a cellular phone.

1. A regulating apparatus for a swimming pool, which includes a number of sensors to measure variables and generate input data relating to the swimming pool; a processing unit to receive the input data and to generate output data; an actuator to control equipment in response to the output data; and an operator interface to allow programming of operating parameters into the processing unit; wherein said equipment includes an ultraviolet unit and an ionization unit capable of automatically regulating the ion concentration of the water in said swimming pool.

2. The regulating apparatus set forth in claim 1 wherein said input data includes the values of two or more parameters selected from the group of: water temperature, pH level, conductivity, total pool water volume, and flow rate of the circulation pump.

3. The regulating apparatus set forth in claim 1 wherein said input data includes the values of two or more parameters selected from the group of water temperature, pH level, conductivity, ion concentration, total pool water volume, and flow rate of the circulation pump.

4. The regulating apparatus set forth in claim 2 wherein said automatic regulation of said ion concentration is accomplished by means of regulating the voltage of said ionization unit in response to the values of at least two of said two or more parameters.

5. The regulating apparatus set forth in claim 3 wherein said automatic regulation of said ion concentration is accomplished by means of regulating the voltage of said ionization unit in response to the value of said ion concentration.

6. The regulating apparatus set forth in claim 1 wherein said ionization unit generates activated copper ions in said swimming pool.

7. The regulating apparatus of claim 1 wherein said ionization unit further comprises at least one input aperture and at least one output aperture wherein said at least one input aperture and said at least one output aperture are located in such positions that an elevation and lateral offset exists between them; and an electrode.

8. A regulating system for water in a swimming pool comprising:
one or more sensors to measure a plurality of variables and to generate input data based upon said plurality of variables;
a processing unit configured to receive said input data, to evaluate said input data, and to generate output data;
an actuator to receive said output data and so further adapted to control equipment in response to said output data;
an operator interface to allow programming of operating parameters into the processing unit and to further allow operator observation of the value of said plurality of variables;
an ultraviolet unit controlled by said actuator; and
an ionization unit controlled by said actuator
whereby said ionization unit is capable of automatically regulating the ion concentration of said water based upon said value of said plurality of variables.

9. The regulating system set forth in claim 8 where said plurality of variables includes at least one of the following: water temperature, pH, flow-rate, conductivity or ion concentration.

10. The regulating system set forth in claim 8 wherein said ionization unit regulates the ion concentration in said water by means of regulating the voltage of said ionization unit in response to the value of at least one of said plurality of variables.

11. The regulating system of claim 8 wherein the actual ion concentration in said water is at least one of said plurality of variables.

12. A method of managing a swimming pool, comprising the steps of (i) selecting a series of operating parameters relating to the swimming pool; (ii) measuring variables relating to the swimming pool; (iii) comparing the variables with the operating parameters to determine the status of the swimming pool; (iv) displaying the status on an operator interface; (v) providing instructions on altering the variables to maintain an optimal status; (vi) calculating the ion concentration of the water of said swimming pool from said variables; (vii) automatically regulating the current flow on an ionization unit in order to maintain the ion concentration within pre-determined operating parameters.

13. The method set forth in claim 12 wherein said calculating further comprises calculating the concentration of activated copper ions in said water.

14. The method set forth in claim 12 wherein said regulating further comprises regulating the concentration of activated copper ions in said water.
